(19) United States
(12) Patent Application Publication
(10) Pub. No.: US 2023/0194380 A1
(43) Pub. Date: Jun. 22, 2023

(54) METHOD OF DETECTING LEAKAGE IN WATER ELECTROLYZER, METHOD OF GENERATING HYDROGEN, PROGRAM FOR DETECTING LEAKAGE IN WATER ELECTOLYZER, AND WATER ELECTROLYZER

(71) Applicant: TOYOTA JIDOSHA KABUSHIKI KAISHA, Toyota-shi (JP)

(72) Inventor: Keisuke FUJITA, Susono-shi (JP)

(73) Assignee: TOYOTA JIDOSHA KABUSHIKI KAISHA, Toyota-shi (JP)

(21) Appl. No.: 18/060,474

(22) Filed: Nov. 30, 2022

(30) Foreign Application Priority Data
Dec. 16, 2021 (JP) 2021-204299

(51) Int. Cl. G01M 3/26; C25B 15/025; C25B 9/23; C25B 1/04

(52) U.S. Cl. CPC G01M 3/26; C25B 15/025; C25B 9/23; C25B 1/04

(57) ABSTRACT

To make it possible to detect whether leakage is external leakage or cross leakage in a water electrolyzer, a valve installed in an oxygen-side path, and a valve installed in a hydrogen-side path are closed; a water electrolysis reaction at a water electrolytic cell is progressed, and leakage in the oxygen-side path and leakage in the hydrogen-side path are determined based on the change in an internal pressure; and a differential pressure is made between the oxygen-side path and the hydrogen-side path, and leakage from a solid polymer electrolyte membrane is determined based on the change in the differential pressure.

### FIELD

The present disclosure relates to leakage detection in a water electrolyzer.

### BACKGROUND

Patent Literature 1 discloses that: the pressure behavior in piping for gas generated in a water electrolyzer is monitored, and it is determined that leakage has occurred if the pressure increases or decreases more slowly than a predetermined speed compared with the pressure behavior in a normal state.

### CITATION LIST

### Patent Literature

Patent Literature 1: JP 2013-249508 A

### SUMMARY

### Technical Problem

The conventional art cannot separately detect whether the leakage is from any sealing portion of joints of pipes etc. (external leakage), or is due to breakage in a solid polymer electrolyte membrane (PEM) that is provided in a water electrolytic cell (cross leakage).

An object of the present disclosure is to make it possible to detect whether leakage is external leakage or cross leakage in a water electrolyzer.

### Solution to Problem

As a result of intensive studies of the inventor of the present disclosure on the conventional art, he got an idea from the fact that detection based on the pressure behavior in piping in a water electrolysis reaction prevents external leakage and cross leakage from being distinguished when the pressure behavior is abnormal, and he embodied measures to detect leakage as external leakage and cross leakage are distinguished, and thereby, completed the present disclosure, which is specifically as follows.

The present application discloses a method of detecting leakage in a water electrolyzer, the water electrolyzer having a water electrolytic cell that has an oxygen-generating electrode disposed on one side thereof across a solid polymer electrolyte membrane and a hydrogen-generating electrode disposed on another side thereof, an oxygen-side path that includes piping disposed for oxygen generated at the water electrolytic cell to flow therein, and a hydrogen-side path that includes piping disposed for hydrogen generated at the water electrolytic cell to flow therein, the method comprising: closing a valve installed in the oxygen-side path, and a valve installed in the hydrogen-side path; progressing a water electrolysis reaction at the water electrolytic cell, and determining leakage in the oxygen-side path and leakage in the hydrogen-side path based on a change in an internal pressure; and making a differential pressure between the oxygen-side path and the hydrogen-side path, and determining leakage from the solid polymer electrolyte membrane based on a change in the differential pressure.

The present application also discloses a method of generating hydrogen, the method comprising: generating hydrogen with periodic leakage detection according to the above-described method in addition to normally generating hydrogen with the water electrolytic cell.

The present application also discloses a non-transitory computer-readable storage medium with an executable program stored thereon, the program being for detecting leakage in a water electrolyzer, the water electrolyzer having a water electrolytic cell that has an oxygen-generating electrode disposed on one side thereof across a solid polymer electrolyte membrane and a hydrogen-generating electrode disposed on another side thereof, an oxygen-side path that includes piping disposed for oxygen generated at the water electrolytic cell to flow therein, and a hydrogen-side path that includes piping disposed for hydrogen generated at the water electrolytic cell to flow therein, wherein the program instructs a controller to perform the following: closing a valve installed in the oxygen-side path, and a valve installed in the hydrogen-side path; progressing a water electrolysis reaction at the water electrolytic cell, and determining leakage in the oxygen-side path and leakage in the hydrogen-side path based on a change in an internal pressure; and making a differential pressure between the oxygen-side path and the hydrogen-side path, and determining leakage from the solid polymer electrolyte membrane based on a change in the differential pressure.

The present application also discloses a water electrolyzer comprising: a water electrolytic cell that has an oxygen-generating electrode disposed on one side thereof across a solid polymer electrolyte membrane and a hydrogen-generating electrode disposed on another side thereof; an oxygen-side path that includes piping disposed for oxygen generated at the water electrolytic cell to flow therein; a hydrogen-side path that includes piping disposed for hydrogen generated at the water electrolytic cell to flow therein; a valve and a pressure gauge that are arranged in the oxygen-side path; another valve and another pressure gauge that are disposed in the hydrogen-side path; and a controller that is electrically connected to the valve, the pressure gauge, the other valve, and the other pressure gauge, wherein the above-described program for detecting leakage in a water electrolyzer is recorded in the controller, and based on the program, the controller receives signals representing pressure values indicated by the pressure gauge and the other pressure gauge, and transmits signals representing instructions to open and close the valve and the other valve.

### Advantageous Effects

The present disclosure makes it possible to separately detect whether external leakage has occurred and whether cross leakage has occurred in a water electrolyzer.

### BRIEF DESCRIPTION OF DRAWINGS

FIG. 1 is a schematic view illustrating structure of a water electrolyzer 10;

FIG. 2 is a schematic view illustrating structure of a water electrolytic cell 21;

FIG. 3 is a schematic view of a computer 50 (controller 50);

FIG. 4 shows a flow of a method of detecting leakage in a water electrolyzer S10; and

FIG. 5 illustrates states of pressures etc. in leakage detection in a water electrolyzer.

### DESCRIPTION OF EMBODIMENTS

### 1. Water Electrolyzer

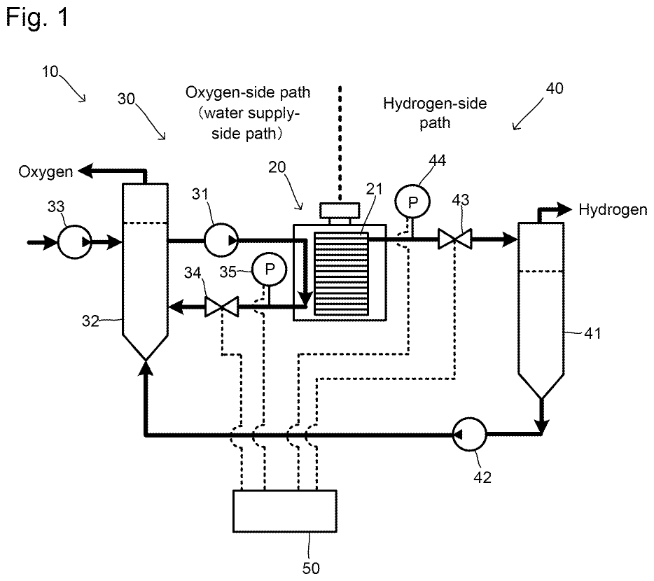

FIG. 1 schematically shows a water electrolyzer 10 according to one embodiment.

In this embodiment, the water electrolyzer 10 has a water electrolytic stack 20, an oxygen-side path 30, a hydrogen-side path 40, and a controller 50. The water electrolyzer 10 is a device to pass an electric current through pure water that is supplied from the oxygen-side path 30 to water electrolytic cells 21 which the water electrolytic stack 20 is equipped with, and thereby, to resolve the water into hydrogen and oxygen, and to separately put the obtained hydrogen in the hydrogen-side path 40.

### 1.1. Water Electrolytic Stack and Water Electrolytic Cells

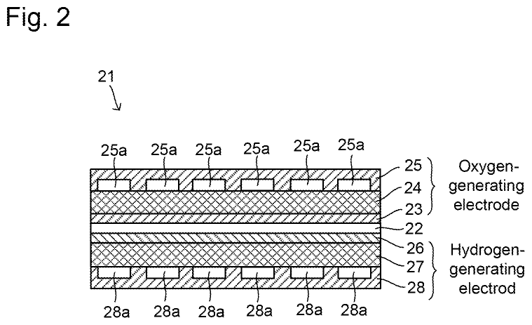

FIG. 2 schematically shows a mode of one of the water electrolytic cells 21. The water electrolytic cell 21 is a unit element for resolving pure water into hydrogen and oxygen. A plurality of such water electrolytic cells 21 are stacked and put in the water electrolytic stack 20.

The water electrolytic cell 21 is as known. In this embodiment, the water electrolytic cell 21 is formed of plural layers: one side thereof across a solid polymer electrolyte membrane 22 is an oxygen-generating electrode (anode), and the other side thereof is a hydrogen-generating electrode (cathode).

The material constituting the solid polymer electrolyte membrane 22 is a solid polymer material, and an example thereof is a proton conductive ion exchange membrane that is formed from a fluorine-based resin, a hydrocarbon-based resin material, or the like. This exhibits excellent proton conductivity (electric conductivity) in a wet state. A more specific example is Nafion (registered trademark), which is a perfluorosulfonic acid membrane.

The oxygen-generating electrode is provided with an oxygen electrode catalyst layer 23, an oxygen electrode gas diffusion layer 24, and an oxygen electrode separator 25 in this order from the solid polymer electrolyte membrane 22 side.

The oxygen electrode catalyst layer 23 is a layer that has an electrode catalyst containing at least one selected from precious metal catalysts such as Pt, Ru and Ir, and oxides thereof.

The oxygen electrode gas diffusion layer 24 is formed of an electroconductive member having gas permeability. A specific example of such a member is a porous electroconductive member formed from a metal fiber or a metal particle.

The oxygen electrode separator 25 is a member provided with flow paths 25a where pure water that is to be supplied to the oxygen electrode gas diffusion layer 24, and obtained oxygen flow.

The hydrogen-generating electrode is installed on a surface of the solid polymer electrolyte membrane 22 on the opposite side of the other surface thereof where the oxygen-generating electrode is arranged. The hydrogen-generating electrode is provided with a hydrogen electrode catalyst layer 26, a hydrogen electrode gas diffusion layer 27, and a hydrogen electrode separator 28 in this order from the solid polymer electrolyte membrane 22 side.

An example of the hydrogen electrode catalyst layer 26 is a layer containing Pt or the like.

The hydrogen electrode gas diffusion layer 27 is formed of an electroconductive member having gas permeability. A specific example of such a member is a porous member such as a carbon cloth and a carbon paper.

The hydrogen electrode separator 28 is a member provided with flow paths 28a where separated hydrogen and the accompanying water flow.

An electric current is passed between the oxygen-generating electrode and the hydrogen-generating electrode, and thereby, pure water (H₂O) that is supplied via the flow paths 25a of the oxygen electrode separator 25 to the oxygen-generating electrode is resolved in the oxygen electrode catalyst layer 23, which has electric potential then, into oxygen, electrons, and protons (H⁺). At this time, the protons pass through the solid polymer electrolyte membrane 22 to move to the hydrogen electrode catalyst layer 26. The electrons separated in the oxygen electrode catalyst layer 23 pass through an external circuit to reach the hydrogen electrode catalyst layer 26. The protons receive the electrons in the hydrogen electrode catalyst layer 26, so that hydrogen is generated. The generated hydrogen reaches the hydrogen electrode separator 28, is discharged via the flow paths 28a, and moves to the hydrogen-side path 40. The oxygen separated in the oxygen electrode catalyst layer 23 reaches the oxygen electrode separator 25, is discharged via the flow path 25a, and moves to the oxygen-side path 30.

### 1.2. Oxygen-Side Path (Water Supply-Side Path)

The oxygen-side path (water supply-side path) 30 is a path that is to supply pure water to the water electrolytic stack 20, and to obtain oxygen, and that includes piping. In the oxygen-side path 30, pure water is supplied to the water electrolytic stack 20 from a pump 31, and generated oxygen and unused water are discharged from the water electrolytic stack 20, and are supplied to a gas-liquid separator 32. In the gas-liquid separator 32, pure water and oxygen are separated. The separated oxygen is discharged; and the pure water is supplied again to the pump 31. Pure water is supplied from a pump 33 to the gas-liquid separator 32 when the pure water to be supplied to the pump 31 runs short. These instruments are connected by the piping.

In the oxygen-side path 30, a valve 34 (solenoid valve in this embodiment) is arranged between a discharge site from the water electrolytic stack 20, and the gas-liquid separator 32; and a pressure gauge 35 is further provided between the valve 34 and the discharge site from the water electrolytic stack 20.

### 1.3. Hydrogen-Side Path

The hydrogen-side path 40 is a path including piping to take out hydrogen separated in the water electrolytic stack 20. In the hydrogen-side path 40, hydrogen and water (pure water) discharged from the water electrolytic stack 20 are supplied to a gas-liquid separator 41. In the gas-liquid separator 41, water and hydrogen are separated. The separated hydrogen is collected; and the water is sent to the gas-liquid separator 32 in the oxygen-side path 30 with a pump 42, and is utilized again. These instruments are connected by the piping.

In the hydrogen-side path 40, a valve 43 (solenoid valve in this embodiment) is arranged between a discharge site from the water electrolytic stack 20, and the gas-liquid separator 41; and a pressure gauge 44 is further provided between the valve 43 and the discharge site from the water electrolytic stack 20.

### 1.4. Controller

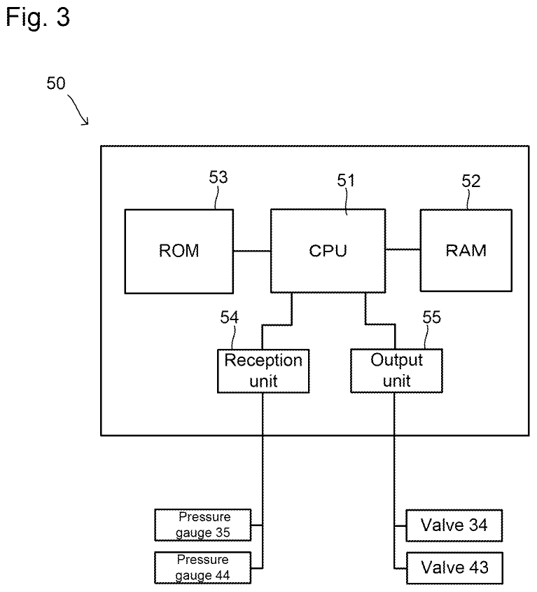

The controller 50 is a controller for carrying out, in the water electrolyzer 10, a method of detecting leakage in a water electrolyzer according to the present disclosure. The mode of the controller 50 is not particularly limited, but the controller 50 can be typically configured by a computer. FIG. 3 schematically shows an example of the configuration of a computer 50 as the controller 50.

The computer 50 is provided with a CPU (Central Processing Unit) 51 that is a processor, a RAM (Random Access Memory) 52 that operates as a work area, a ROM (Read-Only Memory) 53 as a storage medium, a reception unit 54 that is an interface for the computer 50 to receive both wired and wireless information, and an output unit 55 that is an interface for the computer 50 to transmit both wired and wireless information to the outside.

The pressure gauge 35 in the oxygen-side path 30, and the pressure gauge 44 in the hydrogen-side path 40 are electrically connected to the reception unit 54, so that the reception unit 54 is configured to be able to receive the value of (pressure indicated by) each gauge as a signal.

The valve 34 in the oxygen-side path 30, and the valve 43 in the hydrogen-side path 40 are electrically connected to the output unit 55. Opening and closing of these valves 34 and 43 are controlled by signals from the computer 50.

A computer program for executing the steps of the method of detecting leakage in a water electrolyzer according to the present disclosure is stored in the computer 50 as specific instructions. In the computer 50, the CPU 51, the RAM 52, and the ROM 53 as hardware resources cooperate with the computer program. Specifically, the CPU 51 executes, in the RAM 52, which operates as a work area, the computer program recorded in the ROM 53 based on the signals from the pressure gauges 35 and 44, which are acquired via the reception unit 54 and represent the pressure values, and thereby, implements the operation. Information acquired or created by the CPU 51 is stored in the RAM 52. The signals of opening and closing are also transmitted to the valves 34 and 43 via the output unit 55 as necessary based on the steps of the method of detecting leakage in a water electrolyzer according to the present disclosure.

Next, the method of detecting leakage in a water electrolyzer will be specifically described.

### 2. Method of Detecting Leakage in Water Electrolyzer

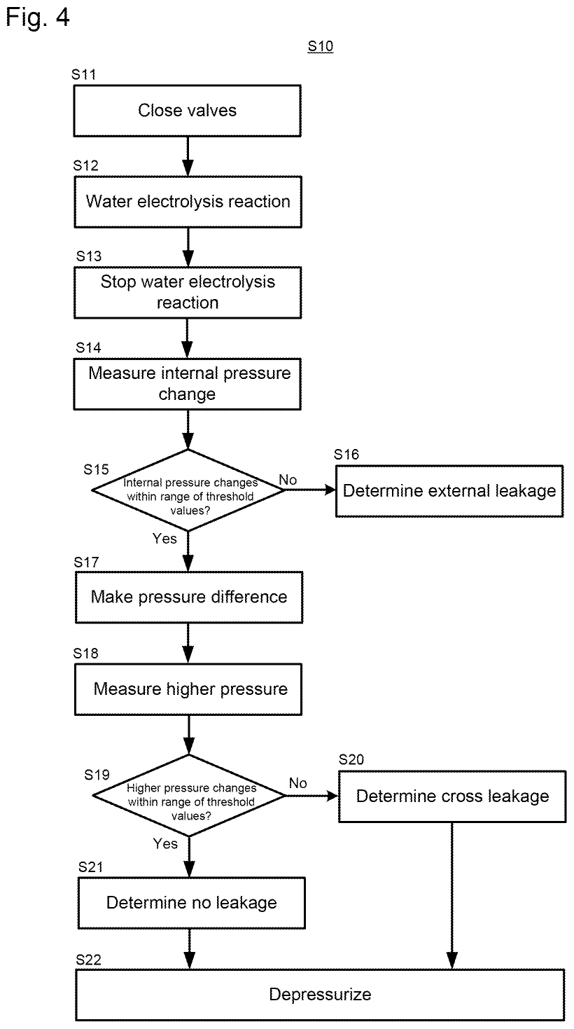

FIG. 4 shows a flow of a method of detecting leakage in a water electrolyzer S10 according to one embodiment of the present disclosure (hereinafter may be referred to as “detection method S10”). As seen in FIG. 4, the detection method S10 includes the steps S11 to S22. The above-described computer program stored in the controller 50 includes specific instructions for the computer to execute each of the steps in this detection method S10.

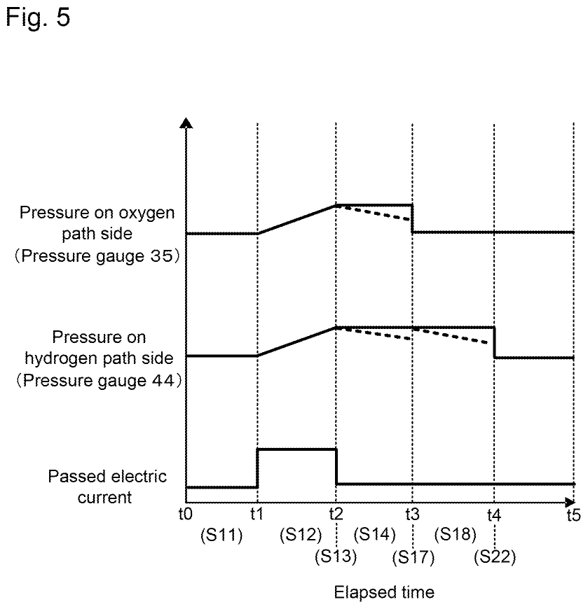

FIG. 5 shows an example of transition of the pressure indicated by the pressure gauge 35 installed in the oxygen-side path 30, an example of transition of the pressure indicated by the pressure gauge 44 installed in the hydrogen-side path 40, and an example of transition of an electric current passed for water electrolysis, in the detection method S10. In FIG. 5, the horizontal axis shows the elapsed time.

### 2.1. Step S11

In the step S11, the valve 34 installed in the oxygen-side path 30, and the valve 43 installed in the hydrogen-side path 40 are closed. This corresponds to the elapsed time from t0 before t1 in FIG. 5. Here, just the valves 34 and 43 are closed but no electric current is passed. Thus, the pressures indicated by the pressure gauges 35 and 44 are each constant.

### 2.2. Step S12

In the step S12, an electric current is passed to cause a water electrolysis reaction. This corresponds to the elapsed time from t1 before t2. Here, a constant electric current is passed, which is followed by a water electrolysis reaction, and thus, hydrogen and oxygen (i.e., gas) are generated. Therefore, the pressures indicated by the pressure gauges 35 and 44 each gradually increase.

### 2.3. Step S13

In the step S13, passing an electric current is stopped when the pressure gauges 35 and 44 each indicate a predetermined pressure (when the internal pressure reaches a predetermined pressure), so that the water electrolysis reaction is stopped. This corresponds to the elapsed time t2. This stops the gas from being generated, so that the pressures do not increase any more.

### 2.4. Step S14

In the step S14, a change in the pressure indicated by each of the pressure gauges 35 and 44 (change in the internal pressure) is measured during a predetermined time (elapsed time immediately after t2 until t3).

### 2.5. Steps S15 and S16

In the step S15, it is determined whether the change in the internal pressure measured in the step S14 is within the range of threshold values.

If the internal pressure changes (decreases) out of the range of the threshold values, No is selected. For example, this is a case where the pressure changes as indicated by the dotted lines between t2 and t3 in FIG. 5. In this case, at least external leakage has occurred. Thus, the method proceeds with the step S16, and it is determined that external leakage has occurred. In the step S16, it is informed the outside that external leakage has occurred, for example, on a display.

If the internal pressure does not change out of the range of the threshold values, Yes is selected. For example, this is transition as indicated by the solid lines between t2 and t3 in FIG. 5. In this case, at least external leakage has not occurred, and thus, the method proceeds to the step S17.

### 2.6. Step S17

In the step S17, the pressure in the oxygen-side path 30 or the hydrogen-side path 40 is decreased to make a pressure difference (differential pressure) between the oxygen-side path 30 and the hydrogen-side path 40, which can be carried out specifically by opening the valve 34 or 43. This corresponds to the elapsed time t3 in the example of FIG. 5. Here, the valve 34 on the oxygen path side is opened. Thus, in FIG. 5, the pressure gauge 44 keeps a high pressure indicated while the pressure indicated by the pressure gauge 35 decreases.

### 2.7. Step S18

In the step S18, a change in a higher pressure among the pressures in which the pressure difference was made in the step S17 (change in the internal pressure) during a predetermined time (elapsed time immediately after t3 until t4) is measured. In the example of FIG. 5, this is the change in the pressure in the hydrogen-side path 40 (indicated by the pressure gauge 44).

### 2.8. Steps S19, S20 and S21

In the step S19, it is determined whether the change in the internal pressure measured in the step S18 is within the range of threshold values.

If the internal pressure changes (decreases) out of the range of the threshold values, No is selected. For example, this is a case where the pressure changes as indicated by the dotted line between t3 and t4 in FIG. 5. In this case, leakage (cross leakage) has occurred from the solid polymer electrolyte membrane 22. Thus, the method proceeds to the step S20, and it is determined that cross leakage has occurred. In the step S20, it is informed the outside that cross leakage has occurred, for example, on a display.

If the internal pressure does not change out of the range of the threshold values, Yes is selected. For example, this is transition as indicated by the solid line between t3 and t4 in FIG. 5. In this case, no cross leakage has occurred, and thus, the method proceeds to the step S21. In the step S21, it is determined that no cross leakage has occurred. In the step S21, it is informed the outside that no leakage has occurred, for example, on a display since it becomes clear from each of the steps so far that neither external leakage nor cross leakage has occurred.

### 2.9. Step S22

In the step S22, the pressure that was not decreased in the step S17 among the pressures in the oxygen-side path 30 and the hydrogen-side path 40 is decreased (depressurized) after the steps S20 and S21 in order to end the leakage detection in the water electrolytic device, which can be specifically carried out by opening a valve that still closes among the valves 34 and 43. This corresponds to the elapsed time t4 in the example of FIG. 5. Here, the valve 43 in the hydrogen-side path 40 is opened. Therefore, the pressure indicated by the pressure gauge 44 decreases in FIG. 5.

This ends the detection.

### 3. Effects etc.

The present disclosure makes it possible to separately detect whether external leakage has occurred and whether cross leakage has occurred in a water electrolyzer. The present disclosure provided with the controller 50 also makes it possible to automatically carry out such detection with a computer program.

Such detection can offer a method of periodically detecting leakage by the method of detecting leakage in a water electrolyzer according to the present disclosure in addition to normally generating hydrogen with water electrolytic cells, which makes it possible to quickly grasp the occurrence of leakage and the cause of the leakage.

### REFERENCE SIGNS LIST

10 water electrolyzer
20 water electrolytic stack
21 water electrolytic cell
30 oxygen-side path (water supply-side path)
34 valve
35 pressure gauge
40 hydrogen-side path
43 valve
44 pressure gauge
50 controller

What is claimed is:

1. A method of detecting leakage in a water electrolyzer, the water electrolyzer having a water electrolytic cell that has an oxygen-generating electrode disposed on one side thereof across a solid polymer electrolyte membrane and a hydrogen-generating electrode disposed on another side thereof, an oxygen-side path that includes piping disposed for oxygen generated at the water electrolytic cell to flow therein, and a hydrogen-side path that includes piping disposed for hydrogen generated at the water electrolytic cell to flow therein, the method comprising:
closing a valve installed in the oxygen-side path, and a valve installed in the hydrogen-side path;
progressing a water electrolysis reaction at the water electrolytic cell, and determining leakage in the oxygen-side path and leakage in the hydrogen-side path based on a change in an internal pressure; and
making a differential pressure between the oxygen-side path and the hydrogen-side path, and determining leakage from the solid polymer electrolyte membrane based on a change in the differential pressure.

2. A method of generating hydrogen, the method comprising:
generating hydrogen with periodic leakage detection according to the method defined in claim 1 in addition to normally generating hydrogen with the water electrolytic cell defined in claim 1.

3. A non-transitory computer-readable storage medium with an executable program stored thereon, the program being for detecting leakage in a water electrolyzer, the water electrolyzer having a water electrolytic cell that has an oxygen-generating electrode disposed on one side thereof across a solid polymer electrolyte membrane and a hydrogen-generating electrode disposed on another side thereof, an oxygen-side path that includes piping disposed for oxygen generated at the water electrolytic cell to flow therein, and a hydrogen-side path that includes piping disposed for hydrogen generated at the water electrolytic cell to flow therein, wherein the program instructs a controller to perform the following:
closing a valve installed in the oxygen-side path, and a valve installed in the hydrogen-side path;
progressing a water electrolysis reaction at the water electrolytic cell, and determining leakage in the oxygen-side path and leakage in the hydrogen-side path based on a change in an internal pressure; and
making a differential pressure between the oxygen-side path and the hydrogen-side path, and determining leakage from the solid polymer electrolyte membrane based on a change in the differential pressure.

4. A water electrolyzer comprising:
a water electrolytic cell that has an oxygen-generating electrode disposed on one side thereof across a solid polymer electrolyte membrane and a hydrogen-generating electrode disposed on another side thereof;
an oxygen-side path that includes piping disposed for oxygen generated at the water electrolytic cell to flow therein;
a hydrogen-side path that includes piping disposed for hydrogen generated at the water electrolytic cell to flow therein;
a valve and a pressure gauge that are arranged in the oxygen-side path;
another valve and another pressure gauge that are disposed in the hydrogen-side path; and
a controller that is electrically connected to the valve, the pressure gauge, the other valve, and the other pressure gauge, wherein
the program for detecting leakage in a water electrolyzer defined in claim 3 is recorded in the controller, and
based on the program, the controller receives signals representing pressure values indicated by the pressure gauge and the other pressure gauge, and transmits signals representing instructions to open and close the valve and the other valve.
